(19) United States
(12) Patent Application Publication
(10) Pub. No.: US 2006/0008702 A1
(43) Pub. Date: Jan. 12, 2006

(54) Secondary battery

(76) Inventors: Sang-Eun Cheon, Suwon-si (KR); Jae-Yul Ryu, Suwon-si (KR); Hye-Won Yoon, Suwon-si (KR); Seok-Yoon Yoo, Suwon-si (KR); Jae-Kyung Kim, Suwon-si (KR); Min-Ho Jang, Suwon-si (KR)

Correspondence Address: CHRISTIE, PARKER & HALE, LLP, PO BOX 7068, PASADENA, CA, 91109-7068, US

(21) Appl. No.: 11/165,828

(22) Filed: Jun. 23, 2005

(30) Foreign Application Priority Data
Jun. 23, 2004 (KR) 10-2004-0047013
Mar. 8, 2005 (KR) 10-2005-0019038
Jun. 22, 2005 (KR) 10-2005-0053943
Jun. 22, 2005 (KR) 10-2005-0053961

(51) Int. Cl. H01M 2/02; H01M 2/26; H01M 2/14

(52) U.S. Cl. 429/164; 429/94; 429/246; 429/161

(57) ABSTRACT

A secondary battery includes an electrode assembly with a positive electrode, a negative electrode and a separator disposed between the positive and the negative electrodes, and a case in which the electrode assembly is mounted. At least one of the positive and the negative electrodes has a leading edge with a rigidity reinforcing member.

### CROSS REFERENCE TO RELATED APPLICATIONS

This application claims priority to and the benefit of Korean Patent Application Nos. 10-2004-0047013, 10-2005-0019038, 10-2005-0053943, and 10-2005-0053961 filed in the Korean Intellectual Property Office on Jun. 23, 2004, Mar. 8, 2005, Jun. 22, 2005, and Jun. 22, 2005, respectively, the entire disclosures of which are incorporated herein by reference.

### FIELD OF THE INVENTION

The present invention relates to a secondary battery, and in particular, to an electrode assembly for a secondary battery.

### BACKGROUND OF THE INVENTION

Secondary batteries are based on a rechargeable mechanism distinguished from that of primary cells where only the irreversible conversion of chemical to electrical energy is made. Secondary batteries may be classified into low-capacity batteries, which use a single battery cell packaged in the form of a pack, and high-capacity batteries, which use scores of battery cells packaged into a battery pack. The low-capacity batteries are used as the power source for small electronic devices such as cellular phones, laptop computers, and camcorders, while the high-capacity batteries are used as the power source for devices such as motors in hybrid electric vehicles and the like.

Secondary batteries are formed of various shapes including cylindrical shapes and prismatic shapes. An electrode assembly may include an insulating separator disposed between sheet-type positive and negative electrodes and mounted within a case with a cap assembly fitted to the case.

The positive and the negative electrodes are each formed by coating an active material on a current collector. Depending upon the presence or absence of the active material coated on the collector, the region coated with the active material is called “the coated region,” while the region with no active material is called the “uncoated region.”

The positive electrode, the separator and the negative electrode are often wound in a jelly roll configuration, such as for a cylindrical-shaped battery, or wound in a jelly roll configuration and pressed, such as for a prismatic-shaped battery.

When an electrode assembly is prepared to fabricate a secondary battery, the positive and the negative electrodes are laminated together with the separator, and wound. Sometimes, upon winding the electrode assembly, the initial wound portion may be crumpled, making the final product defective.

This problem is encountered because the positive and the negative current collectors that form the electrode assemblies are formed from thin plates, and the rigidity thereof is weak.

When the fabricated electrode assembly is defective due to the above problem, the current collector inevitably becomes defective making the secondary battery unreliable.

When the above problem is encountered with a secondary battery in a service requiring high power output such as for driving a motor, it is particularly difficult to use such a battery and device failure may result.

### SUMMARY OF THE INVENTION

In accordance with an embodiment of the present invention, a secondary battery is provided in which has a high quality electrode assembly with well-wound electrodes.

According to one embodiment of the present invention, a secondary battery includes an electrode assembly with a positive electrode, a negative electrode and a separator disposed between the positive and the negative electrodes, and a case in which the electrode assembly is mounted. At least one of the positive and the negative electrodes has a leading edge with a rigidity reinforcing member.

According to an embodiment of the invention, the electrode assembly is formed in the shape of a jelly roll.

According to an embodiment of the invention, the electrode has a current collector with an active material layer formed on at least a portion of the current collector. The region of the current collector with the active material is referred to as an “active material region,” and the region without active material is referred to as a “non-active material region.”

According to an embodiment of the invention, a non-active material region is formed on the periphery of one side of the current collector along the length of the current collector.

According to one embodiment of the invention, a rigidity reinforcing member is also formed on the active material layer.

According to various embodiments of the invention, the rigidity reinforcing member may be formed over a non-active material region of the current collector.

The rigidity reinforcing member may also be formed to extend over a portion of the active material layer.

The active material layer may also be placed on one side surface of the current collector with the rigidity reinforcing member formed on an opposite side surface of the current collector with no active material layer.

The rigidity reinforcing member may be a film formed separately from the electrode, and attached to the electrode.

The film may be placed only on one side surface of the current collector, or it may be placed on both side surfaces of the current collector while surrounding the leading edge of the current collector.

Suitable films are made from polyester, polyimide, polyphenylene sulfide, glass fiber, vinyl chloride and synthetic fibers.

The width of the film placed on the surface of the current collector may be from 2 to 15 cm.

The film may be attached to the electrode by an adhesive.

The rigidity reinforcing member may be formed by overlapping the current collector.

The rigidity reinforcing member may be formed by making a portion of the current collector corresponding to the leading edge of the electrode thicker than other portions of the electrode.

The rigidity reinforcing member may be structured such that the thickness of the active material layer formed on the current collector corresponding to the leading edge of the electrode is larger than the thickness of the active material layer formed on other portions of the current collector.

According to other embodiments of the present invention, a secondary battery includes such an electrode assembly with a positive electrode, a negative electrode and a separator disposed between the positive and the negative electrodes, and a case in which the electrode assembly is mounted. At least one of the positive and the negative electrodes may have a leading edge with a thickness different from the thickness of other portions of the electrode.

The thickness of the leading edge of the electrode may be larger than the thickness of other portions of the electrode.

### BRIEF DESCRIPTION OF THE DRAWINGS

FIG. 1 is a sectional view of a secondary battery according to a first embodiment of the present invention;

FIG. 2 is an exploded perspective view of an electrode assembly for the secondary battery according to the first embodiment of the present invention;

FIG. 3A is a partial plan view of a positive electrode for the secondary battery according to the first embodiment of the present invention;

FIG. 3B is a partial plan view of a negative electrode for the secondary battery according to the first embodiment of the present invention;

FIGS. 4A, 4B, 4C and 4D illustrate a rigidity reinforcing member for the secondary battery according to the first embodiment of the present invention;

FIGS. 5A, 5B and 5C illustrate a rigidity reinforcing member for a secondary battery according to a second embodiment of the present invention;

FIGS. 6A, 6B and 6C illustrate a rigidity reinforcing member for a secondary battery according to a third embodiment of the present invention; and

FIGS. 7A and 7B illustrate a rigidity reinforcing member for a secondary battery according to a fourth embodiment of the present invention.

### DETAILED DESCRIPTION

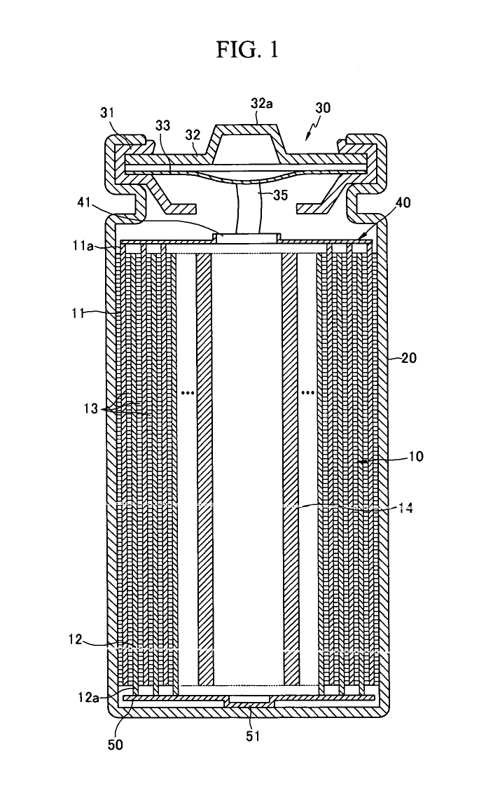

FIG. 1 is a sectional view of a secondary battery according to a first embodiment of the present invention. According to this embodiment, an electrode assembly 10 is formed by interposing an insulating separator 13 between positive and negative electrodes 11 and 12, and winding them. The electrode assembly 10 is mounted within a cylindrical-shaped or hexahedral-shaped case 20 through an opening portion thereof. The opening portion of the case 20 is sealed by a cap assembly 30 via a gasket 31.

The case 20 is formed of a conductive metallic material, such as aluminum, aluminum alloy, or nickel-plated steel. For this embodiment, the case 20 is of a cylindrical shape with an inner space in which the electrode assembly 10 is mounted, but the invention is not limited thereto.

The cap assembly 30 includes a cap plate 32 with an external terminal 32a, and a gasket 31 for insulating the case 20 from the cap plate 32. The cap assembly 30 may further include a vent plate 33 with a safety vent, which is broken under a predetermined pressure in order to discharge the gas generated in the case 20 and prevent the secondary battery from exploding. However, the safety vent is not limited to that formed at the vent plate 33, but may be varied in structure provided that it electrically insulates the electrode assembly 10 from the external terminal 32a of the cap assembly 30 under the predetermined pressure.

The gasket 31 based on an insulating material seals the case 20, and electrically insulates the cap assembly 30 being the cathode from the case 20 being the anode.

The cap assembly 30 is electrically connected to the electrode assembly 10 via a lead element 35.

The electrode assembly for the secondary battery according to the first embodiment of the present invention will be now explained.

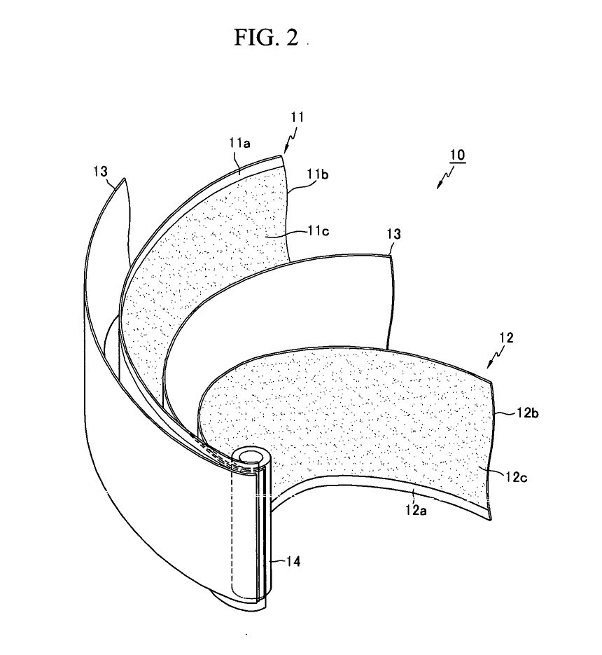

As shown in FIG. 2, with the electrode assembly 10, a separator 13 is disposed between the positive and negative electrodes 11 and 12, and spirally wound together. The positive and the negative electrodes 11 and 12 have active material layers formed by coating an active material on current collectors 11b and 12b, respectively.

The active material is not coated on the length of one peripheral side of each of current collectors 11 and 12. That is, the peripheral portions of the current collectors 11 and 12 are uncoated, and therefore, exposed.

For explanatory convenience, the regions of the positive and the negative electrodes 11 and 12 with the active material layer will be referred to hereinafter as “active material regions” 11c and 12c, and the regions thereof with no active material will be referred to as the “non-active material regions” 11a and 12a.

With the formation of the electrode assembly 10, the non-active material region 11a of the positive electrode 11 and the non-active material region 12a of the negative electrode are on opposite sides of the electrode assembly 10 and protrude out past the edges of the separator 13.

A positive current collecting plate 40 is welded to the non-active material region 11a of the positive electrode 11, and a negative current collecting plate 50 is welded to the non-active material region 12a of the negative electrode 12. The positive current collecting plate 40 is also electrically connected to a vent plate 33 of the cap assembly 30 via the lead element 35, and the negative current collecting plate 50 is welded to the bottom of the case 20 while being electrically connected thereto.

As shown in FIG. 2, the positive electrode 11, the negative electrode 12 and the separator 13 are wound around a core 14 in a jelly roll configuration. At least one of the positive and the negative electrodes 11 and 12 is provided with a rigidity reinforcing member so that the inside end of the relevant electrode may be wound tightly around the core 14 without being crumpled.

In this embodiment, a rigidity reinforcing member is separately formed at each of the positive and the negative electrodes 11 and 12. Each rigidity reinforcing member is formed with films 15 attached to one end of each of the positive and the negative electrodes 11 and 12 separately. It should be apparent to one of ordinary skill in the art that that when winding the electrode assembly 10 into a jelly roll configuration with the core 14 at the center, the winding starts at the ends of the positive and negative electrodes 11 and 12 that include the film 15. Therefore, this end of each of the positive and negative electrodes 11 and 12 will be referred to as the “leading edge.”

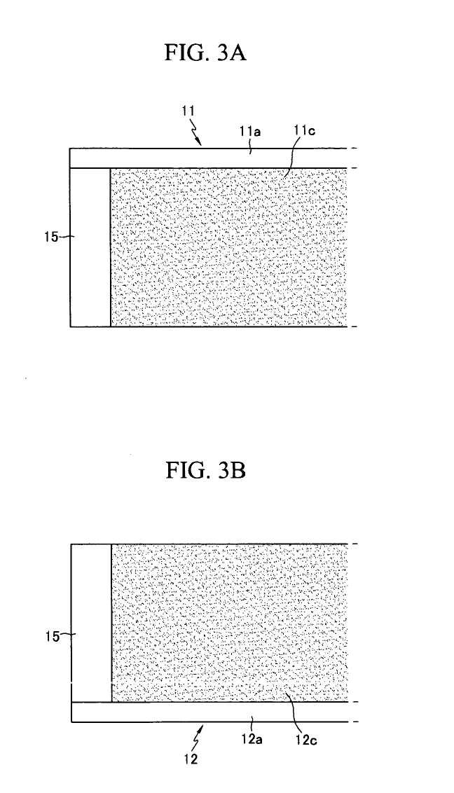

FIG. 3A illustrates the embodiment where a film 15 is formed at the positive electrode 11, and FIG. 3B illustrates the case where a film 15 is formed at the negative electrode 12.

In this embodiment, the films 15 are made of a material such as polyester, polyimide, polyphenylene sulfide, vinyl chloride or synthetic fiber, and each is attached to the leading edge of the positive and the negative electrodes 11 and 12.

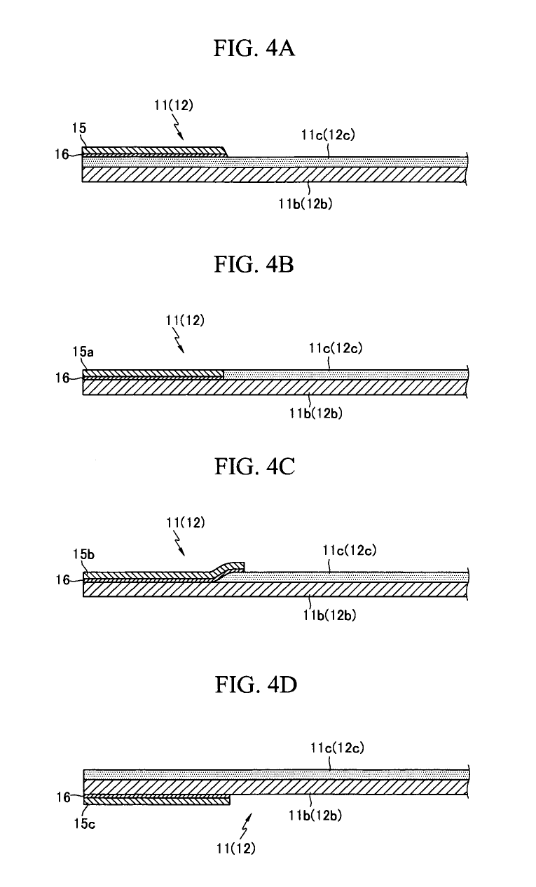

FIGS. 4A to 4D illustrate different variations by which the films 15 are attached to the leading edges of the positive and the negative electrodes 11 and 12.

The films 15, 15a, 15b and 15c shown in FIGS. 4A to 4D are provided on one side surface of each of the positive and the negative electrodes 11 and 12, and attached to the leading edges of the positive and the negative electrodes 11 and 12.

A film 15, 15a and 15b, as shown in FIGS. 4A to 4C is placed on the leading edge of each of the positive and the negative electrodes 11 and 12 on the side with the active material regions 11c and 12c.

According to FIG. 4A, the film 15 may be in contact with the active material layer of the current collectors 11b and 12b, or as shown in FIG. 4B, the film 15a may be in a region of the current collectors 11b and 12b with no active material. Alternatively, as shown in FIG. 4C, the film 15b may contact the current collector at a region with no active material while partially extending over the active material layer.

According to FIG. 4D, the film 15c may be provided on the side of the electrode 11, 12 opposite the side with the active material layer.

An adhesive 16 is used to attach the films 15, 15a, 15b and 15c to the leading edges of the electrodes 11 and 12. In general, the adhesive 16 should not react with the active material of the positive and the negative electrodes 11 and 12, nor should it react with the electrolyte filled within the case 20. An acryl-based material is a suitable material for the adhesive 16.

In one embodiment, the films 15, 15a, 15b and 15c have a width of between about 2 and 15 cm. When the width of the films is less than 2 cm, the area thereof is too small compared to the entire area of the positive and the negative electrodes 11 and 12 to provide the desired rigidity of the positive and the negative electrodes 11 and 12 during the winding of the positive and the negative electrodes 11 and 12. When the film width exceeds 15 cm, the film area is so large compared to the entire area of the positive and the negative electrodes 11 and 12 that the resulting reduction in the area of the active material regions 11c and 12c at the positive and the negative electrodes 11 and 12 reduces the capacity of the electrode assembly 10 as well as the secondary battery.

When films such as the films 15, 15a, 15b or 15c are provided at the positive and the negative electrodes 11 and 12 as the rigidity reinforcing members, with the winding of the positive and the negative electrodes 11 and 12 around the core 14, the rigidity-reinforced leading edges of the positive and the negative electrodes 11 and 12 are not crumpled so that a high quality electrode assembly 10 can be obtained.

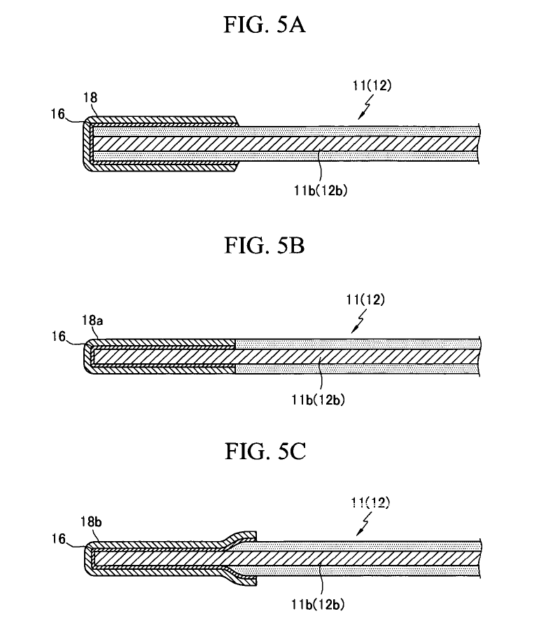

FIGS. 5A to 5C illustrate electrodes according to a second embodiment of the present invention along with variations on the second embodiment.

In this embodiment, the rigidity reinforcing member is formed with films 18, 18a and 18b similar to those of the previous embodiments, except that the current collectors 11b and 12b include active material on both surfaces. For this embodiment, the films 18, 18a and 18b extend around the leading edge of each current collector 11b and 12b of the positive and the negative electrodes 11 and 12.

The structure and the method of attaching the films 18, 18a and 18b to the positive and the negative electrodes 11 and 12 are like those for the previous embodiments. According to FIG. 5A, the electrodes 11 and 12 include active material over the leading edge, and therefore, the film 18 is applied to the active material using an adhesive 16. According to FIGS. 5B and 5C, the leading edge of each electrode 11 and 12 does not include active material, and the films 18a and 18b are applied to the uncoated leading edges of the current collectors 11b and 12b using an adhesive 16. The variation of FIG. 5C differs from that of 5B in that the film 18b and adhesive 16 extend over a portion of the active material layers of the current collectors 11b and 12b.

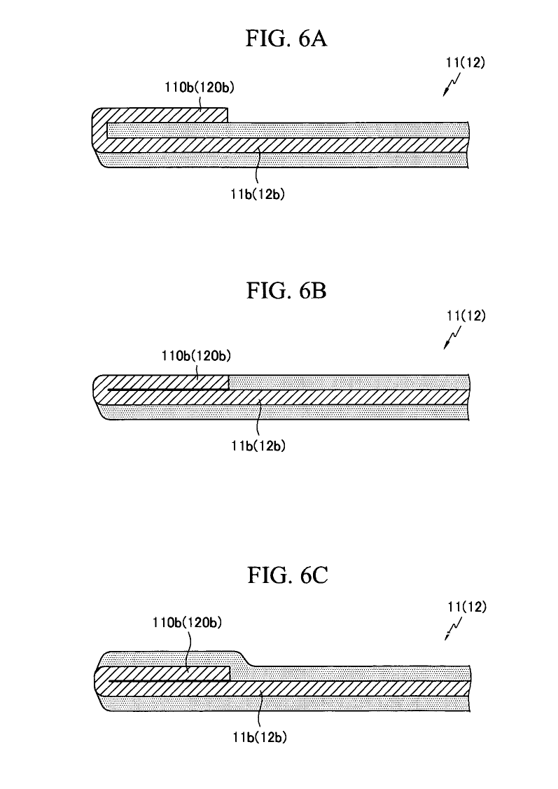

FIGS. 6A to 6C illustrate a secondary battery according to a third embodiment of the present invention along with variations on this third embodiment. According to this embodiment and its variations, the rigidity reinforcing member is formed by folding the leading edge of each current collector 11b and 12b upon itself.

In one variation on this embodiment, the width of the folded portion is between about 2 and 15 cm for the same reasons as mentioned above.

FIG. 6A illustrates the variation where the leading edges 110b and 120b are folded over the active material layer FIG. 6B illustrates the variation where the leading edges 110b and 120b are folded over a portion of the current collectors 11b and 12b with no active material layer. FIG. 6C illustrates the variation where the leading edges 110b and 120b are folded over the current collectors 11b and 12b at a region with no active material layer, and an active material layer is formed on the folded edges 110b and 120b.

In this embodiment, the leading edges of the current collectors 11b and 12b are folded such that the positive and the negative electrodes 11 and 12 partially overlap, increasing the rigidity of the positive and the negative electrodes 11 and 12.

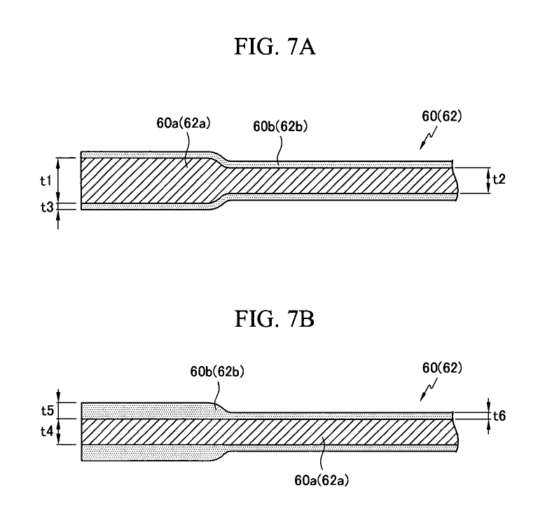

FIGS. 7A and 7B illustrate a secondary battery according to a fourth embodiment of the present invention and a variation.

In this embodiment, the rigidity reinforcing member is structured such that the leading edge portions of the positive and the negative electrodes 60 and 62 are thicker than the other portions of the positive and the negative electrodes 60 and 62.

According to the variation shown in FIG. 7A, the rigidity reinforcing member of the positive and the negative electrodes 60 and 62 are structured such that the thickness t1 of the leading edge of the current collectors 60a and 62a is larger than the thickness t2 of the rest of the current collectors 60a and 62a, thereby making the thickness of the leading edge of the positive and the negative electrodes 60 and 62 thicker than the rest of the positive and the negative electrodes 60 and 62.

In one embodiment, the ratio of t1 to t2 is 1.8:1, and the active material layers 60b and 62b are coated uniformly on the current collectors 60a and 62a to a thickness t3.

According to the variation shown in FIG. 7B, the positive and negative current collectors 60a and 62a have uniform thicknesses t4 over their entire areas thereof, while the active material layers 60b and 62b coated on the current collectors 60a and 62a are partially varied in thickness.

That is, for this variation, the rigidity reinforcing member is structured such that the thicknesses t5 of the portions of the active material layers 60b and 62b corresponding to the leading edges of the positive and the negative electrodes 60 and 62 are larger than the thicknesses t6 of the other portions of the active material layers 60b and 62b.

According to one embodiment for this variation, the ratio of t5 to t6 is 1.8:1. The thickness ratio may also be said to be the ratio of the amount of coating per unit area for the portions of the active material layers 60b and 62b corresponding to the leading edges of the positive and the negative electrodes 60 and 62 to the amount of coating per unit area for the portions of the active material layers 60b and 62b corresponding to other portions of the positive and the negative electrodes 60 and 62.

In this embodiment, the thicknesses of the positive and the negative electrodes 60 and 62 corresponding to the leading edges of the positive and the negative electrodes 60 and 62 are larger than the thicknesses of the other portions of the positive and the negative electrodes 60 and 62. With such a structure, when the positive and the negative electrodes 60 and 62 are wound, crumpling is avoided, resulting in a high quality electrode assembly.

It is explained in various embodiments above that the rigidity reinforcing member is formed at both the positive and the negative electrodes, but the inventive structure is not limited thereto. That is, the rigidity reinforcing member may be formed at only one of the positive and the negative electrodes.

As described above, the leading edges of the electrodes are prevented from being distorted during the process of winding the electrodes around the core due to the formation of the rigidity reinforcing member.

Consequently, a high quality electrode assembly is formed, and the product reliability of the secondary battery is enhanced.

The secondary battery according to the present invention is effectively used as the power source for driving motors in hybrid electric vehicles (HEV), electric vehicles (EA), wireless cleaners, electric bicycles, electric scooters and the like.

Although exemplary embodiments of the present invention have been shown and described, it would be appreciated by those skilled in the art that changes may be made to the embodiments without departing from the principles and spirit of the invention, the scope of which is defined in the claims and their equivalents.

What is claimed is:

1. A secondary battery comprising:
a wound electrode assembly with a positive electrode, a negative electrode, and a separator disposed between the positive electrode and the negative electrode, wherein at least one electrode of the positive electrode and the negative electrode has a leading edge with a rigidity reinforcing member; and
a case in which the electrode assembly is mounted.

2. The secondary battery of claim 1 wherein the electrode assembly is formed in the shape of a jelly roll.

3. The secondary battery of claim 1 wherein the at least one electrode comprises a current collector with an active material layer formed on a portion of the current collector such that the current collector includes an active material region with active material and a non-active material region with no active material.

4. The secondary battery of claim 3 wherein the non-active material region is formed peripherally at one side of the current collector along the length of the current collector.

5. The secondary battery of claim 3 wherein the rigidity reinforcing member is formed on the active material layer.

6. The secondary battery of claim 3 wherein the rigidity reinforcing member is formed over at least a portion of the non-active material region of the current collector.

7. The secondary battery of claim 6 wherein the rigidity reinforcing member is further formed over at least a portion of the active material layer.

8. The secondary battery of claim 3 wherein the active material layer is placed on one side surface of the current collector, and the rigidity reinforcing member is formed on the opposite side surface of the current collector.

9. The secondary battery of claim 3 wherein the rigidity reinforcing member is a film formed separately from the electrode and attached to the electrode.

10. The secondary battery of claim 9 wherein the film is placed on a portion of one side surface of the current collector.

11. The secondary battery of claim 9 wherein the film is placed on at least a portion of each side surface of the current collector while surrounding the leading edge of the current collector.

12. The secondary battery of claim 9 wherein the film comprises a material selected from the group consisting of polyester, polyimide, polyphenylene sulfide, glass fiber, vinyl chloride, and synthetic fiber.

13. The secondary battery of claim 9 wherein the film has a width between 2 and 15 cm.

14. The secondary battery of claim 9 wherein the film is attached to the electrode by an adhesive.

15. The secondary battery of claim 3 wherein the rigidity reinforcing member overlaps the current collector.

16. The secondary battery of claim 3 wherein the rigidity reinforcing member comprises a portion of the current collector corresponding to a leading edge of the electrode that is thicker than other portions of the electrode.

17. The secondary battery of claim 3 wherein the rigidity reinforcing member comprises an active material layer formed on the current collector corresponding to a leading edge of the electrode that is thicker than the active material layer formed on other portions of the current collector.

18. The secondary battery of claim 1 wherein the case is of a cylindrical shape.

19. The secondary battery of claim 1 wherein the battery drives a motor.

20. A secondary battery comprising:
an electrode assembly comprising a positive electrode, a negative electrode, and a separator disposed between the positive and the negative electrodes, wherein at least one electrode of the positive and the negative electrodes has a leading edge with a thickness different from the thickness of other portions of the electrode; and
a case in which the electrode assembly is mounted.

21. The secondary battery of claim 20 wherein the thickness of the leading edge of the at least one electrode is larger than the thickness of other portions of the electrode.

22. The secondary battery of claim 20 wherein the electrode assembly is formed in the shape of a jelly roll.

23. The secondary battery of claim 20 wherein the at least one electrode comprises a current collector and an active material layer formed on a portion of the current collector such that the current collector comprises an active material region with active material and a non-active material region with no active material.

24. The secondary battery of claim 23 wherein the non-active material region is formed peripherally at one side of the current collector along the length of the current collector.

25. The secondary battery of claim 23 wherein the thickness of the portion of the current collector corresponding to a leading edge of the at least one electrode is larger than the thickness of other portions of the electrode.

26. The secondary battery of claim 25 wherein the ratio of the thickness of the portion of the current collector corresponding to the leading edge of the at least one electrode to the thickness of the other portions of the current collector is 1.8:1.

27. The secondary battery of claim 25 wherein the active material layer has a uniform thickness.

28. The secondary battery of claim 23 wherein the thickness of the active material layer corresponding to the leading edge of the electrode is larger than the thickness of the active material layer formed on other portions of the current collector.

29. The secondary battery of claim 28 wherein the ratio of the thickness of the active material layer corresponding to the leading edge of the electrode to the thickness of the active material layer corresponding to other portions of the electrode is 1.8:1.

30. The secondary battery of claim 28 wherein the ratio of the coating per unit area of the active material layer corresponding to the leading edge of the electrode to the coating per unit area of the active material layer corresponding to other portions of the electrode is 1.8:1.

31. The secondary battery of claim 28 wherein the current collector is of a uniform thickness.

32. The secondary battery of claim 20 wherein the case is of a cylindrical shape.

33. The secondary battery of claim 20 wherein the battery drives a motor.
